(19) United States
(12) Patent Application Publication
(10) Pub. No.: US 2025/0187156 A1
(43) Pub. Date: Jun. 12, 2025

(54) RATCHET WRENCH INCLUDING A BICYCLE TOOLSET COMBINED THEREWITH CROSS-REFERENCE

(71) Applicant: Louis CHUANG, TAICHUNG (TW)

(72) Inventor: Louis CHUANG, TAICHUNG (TW)

(21) Appl. No.: 19/057,390

(22) Filed: Feb. 19, 2025

Related U.S. Application Data
(62) Division of application No. 17/939,046, filed on Sep. 7, 2022, now Pat. No. 12,257,674.

(30) Foreign Application Priority Data
Oct. 21, 2021 (TW) 110139123

(51) Int. Cl. B25B 27/00; B25B 13/46; B25B 27/22

(52) U.S. Cl. CPC B25B 27/0071; B25B 13/46; B25B 27/22

(57) ABSTRACT

A ratchet wrench including a bicycle toolset combined therewith includes a main body with a ratchet drive head and an accommodating cavity. A detachable toolset is housed within the cavity and includes a connector, plug, and inflator adapter. The inflator adapter provides an air channel for inflating purposes, ensuring lightweight, multifunctional usability.

### CROSS-REFERENCE

This application is a divisional application of U.S. application Ser. No. 17/939,046, filed on Sep. 7, 2022, which is now allowed, and is hereby incorporated by reference in its entirety.

### BACKGROUND OF THE INVENTION

The present invention relates to a ratchet wrench and, particularly, to a ratchet wrench including a bicycle toolset combined therewith.

TW U.S. Pat. No. 1,471,203 shows a multifunctional toolset for bicycles. The tool includes a body which has a first side, a side opposite to the first side, and an outer peripheral edge between the first and the second sides. The body is recessed and forms at least one groove that creates a space for avoiding contact. The at least one groove is adjacent to the outer peripheral edge of the body. The portion of the at least one groove close to the first side of the body and both sides of the outer peripheral edge are open. The portion of the at least one groove close to the second side of the body has a shielding wall. The shielding wall close the side of the at least one groove which is close to the second side. At least one working head is pivotally connected to the body and engaged in the at least one groove. The end of the at least one working head pivotally connected to the body is in a shape of a flat plate. The at least one working head is movable relative to the body and selectively protrudes from the outer peripheral edge of the body outside the at least one groove.

Bicycles are commonly used as a means of transportation for sports or travel and leisure, and in order to avoid user's burden, bicycle tools are often small in size, light in weight and multi-functional. Thus, the type or the shape of the bicycle tools are often limited. For example, a ratchet wrench, is more convenient for use than a wrench, however, it is larger in size and heavier than the wrench. Therefore, it is difficult to design a ratchet wrench combined with bicycle tools.

The present invention is, therefore, intended to obviate or at least alleviate the problems encountered in the prior art.

### SUMMARY OF THE INVENTION

The present invention provides a ratchet wrench including a bicycle toolset combined therewith. The ratchet wrench comprises a main body having a first end including a ratchet drive head and a second end including an accommodating cavity. The toolset is detachably connected to the main body and comprises a connector, a plug, and an inflator adapter. The connector has a first connecting portion and a second connecting portion at different ends, a plug, and an inflator adapter including a coupling end and an inflator end at different ends. When the toolset is in a combination configuration, the connector, plug, and inflator adapter are coupled together. The first connecting portion is detachably fastened to the main body and disposed in the accommodating cavity. The plug is connected to the first connecting portion and positioned in the cavity. The second connecting portion is inserted into an air channel of the inflator adapter, with the air channel extending from the coupling end to the inflator end.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the invention. It is important, therefore, that the claims be regarded as including such equivalent constructions insofar as they do not deviate from the spirit and scope of the invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new features of the invention will become apparent from the following detailed description of the invention when considered in conjunction with the accompanied drawings.

### BRIEF DESCRIPTION OF DRAWINGS

FIG. 1 is a perspective view of a ratchet wrench including a bicycle toolset combined therewith in accordance with a first embodiment of the present invention.

FIG. 2 is an exploded perspective view of the ratchet wrench of FIG. 1.

FIG. 3 is a cross-sectional view of the ratchet wrench of FIG. 1.

FIG. 4 is another cross-sectional view of the ratchet wrench of FIG. 1.

FIG. 5 is a perspective view of the ratchet wrench of FIG. 1 in a configuration in which a bicycle tool is assembled for an operation.

FIG. 6 is a perspective view of a ratchet wrench including a bicycle toolset combined therewith in accordance with a second embodiment of the present invention.

FIG. 7 is an exploded perspective view of the ratchet wrench of FIG. 6.

FIG. 8 is a cross-sectional view of the ratchet wrench of FIG. 6.

### DETAILED DESCRIPTION OF THE INVENTION

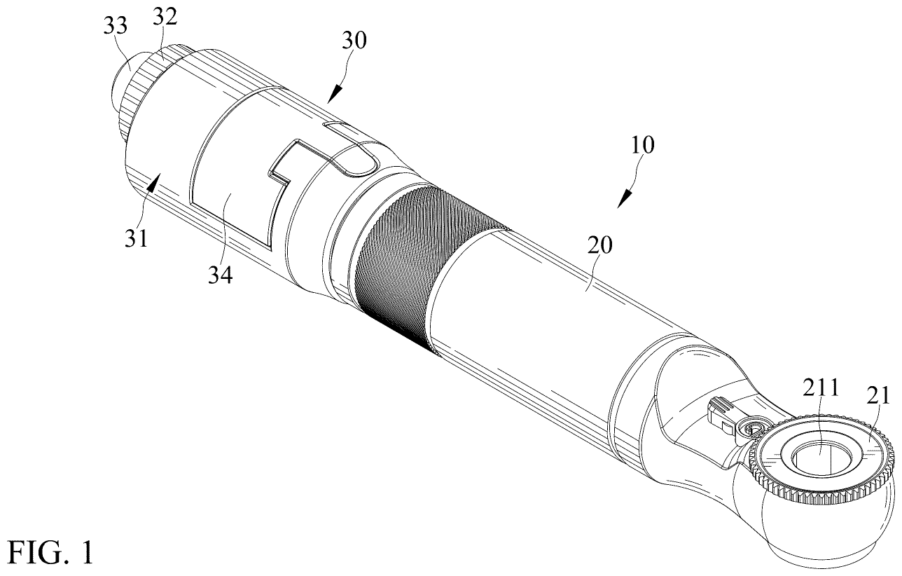

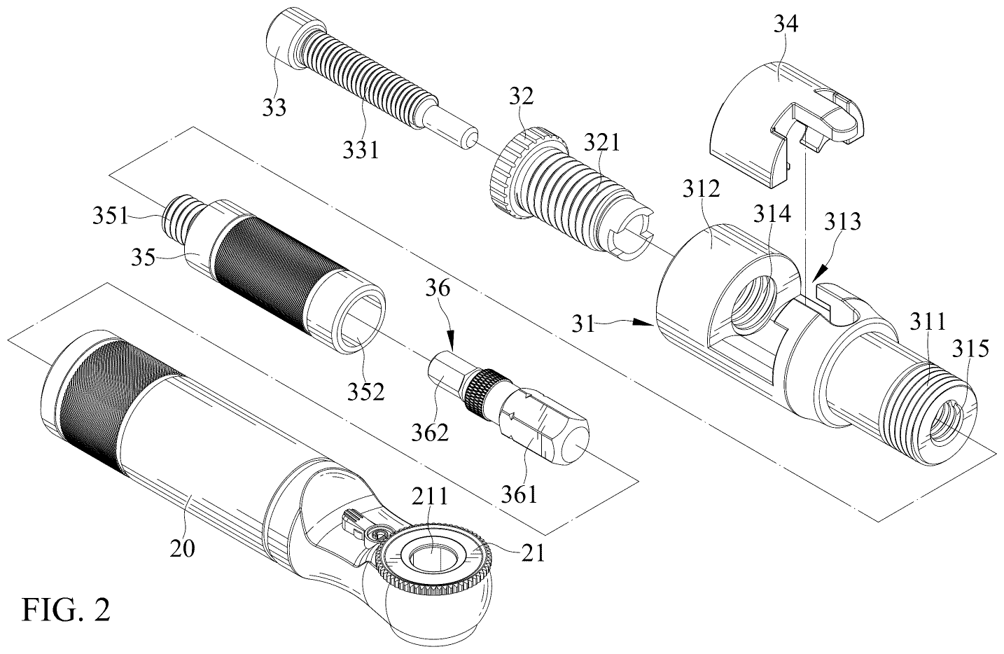

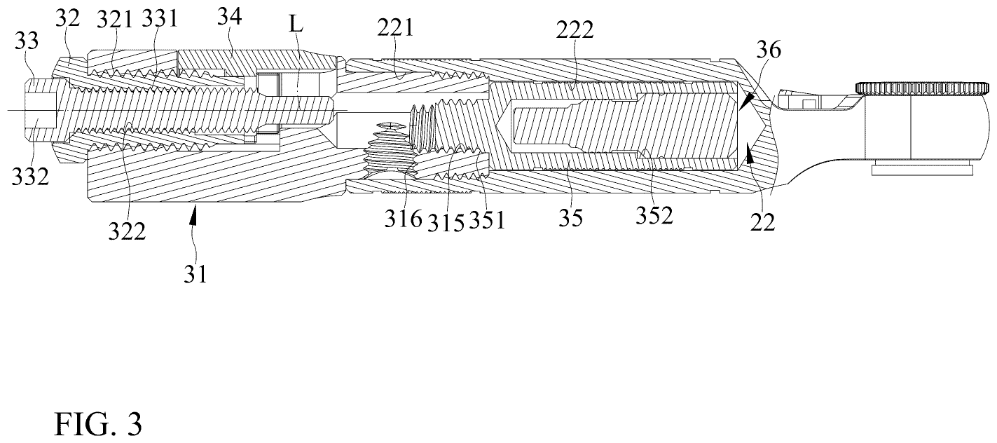

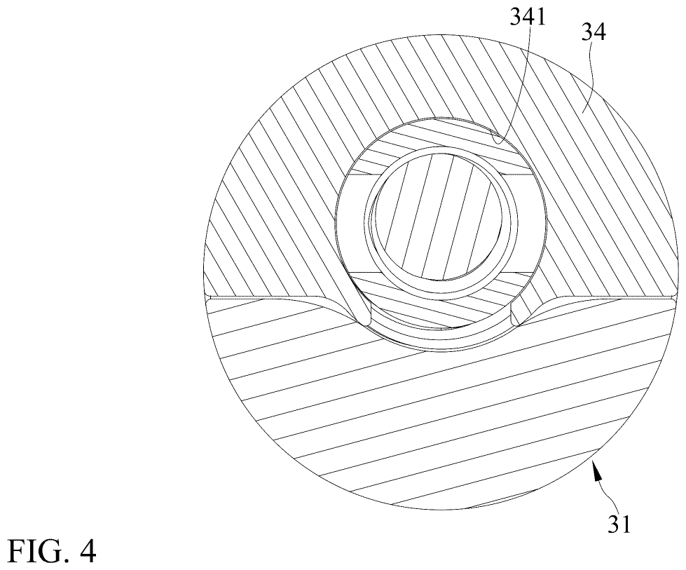

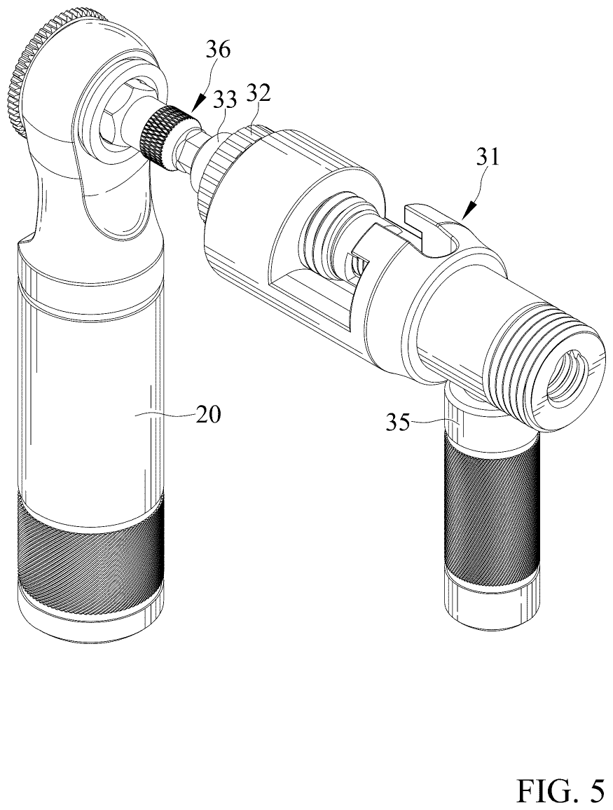

FIGS. 1 through 5 show a ratchet wrench 10 including a bicycle toolset 30 combined therewith in accordance with a first embodiment of the present invention. The ratchet wrench 10 has a main body 20 which has a first end including a ratchet drive head 21 and a second end including an accommodating cavity 22. The accommodating cavity 22 has a first section 221 and a second section 222. The first section 221 is adjacent to an open end of the accommodating cavity 22. The second section 222 is connected to the first section 221 and adjacent to the ratchet drive head 21.

The toolset 30 in a combination configuration is detachably connected to the main body 20 and includes a length disposed in the accommodating cavity 22. The toolset 30 comprises at least one bicycle tool. The toolset 30 is a chain tool which includes a chain tool body 31, a body bolt 32, and an extractor bolt 33. The chain tool body 31 includes a first connecting hole 315 and a second connecting hole 316. The first connecting hole 315 extends along a central axis L. The second connecting hole 316 extends in a direction radial to the central axis L and opens on an outer peripheral edge of the chain tool body 31. The chain tool body 31 has a first connecting portion 311, a second connecting portion 312, and a working area 313 between the first and the second connecting portions 311 and 312. The first connecting hole 315 extends in the first connecting portion 311. The first connecting portion 311 is detachably connected to the main body 20 and disposed in the accommodating cavity 22 when the toolset 30 is in the combination configuration. Specifically, the first connecting portion 311 and the first section 221 are detachably connected with each other when the toolset 30 is in the combination configuration. The first connecting portion 311 and the first section 221 have threads adapted to be detachably engaged with each other. The second connecting portion 312 and the working area 313 are disposed outside the accommodating cavity 22 when the toolset 30 is in the combination configuration. The second connecting portion 312 includes first internal threads 314 extending axially along the central axis L and the body bolt 32 includes first external threads 321 engaged with the first internal threads 314. The body bolt 32 is movable in the working area 313 toward or away from the first connecting portion 311. The body bolt 32 includes second internal threads 322 extending along the central axis L and having a diameter smaller than the first external threads 321. The extractor bolt 33 is engaged with the body bolt 32. The extractor bolt 33 includes second external threads 331 engaged with the second internal threads 322. The extractor bolt 33 is movable in the working area 313 toward or away from the first connecting portion 311.

Further, the toolset 30 includes a closure 34 detachably connected to the chain tool body 31 and configured to enclose the working area 313 and a grip 35 selectively connectible to the chain tool body 31 in a first configuration and a second configuration. When the closure 34 encloses the working area 313, it has a limiting portion 341 configured to limit a movement of the body bolt 32, and the body bolt 32 includes an end adjacent to the working area 313 abutting the limiting portion 341. The grip 35 has a joining portion 351 detachably connectible to the chain tool body 31. The grip 35 in the first configuration includes the joining portion 351 detachably connected to the first connecting hole 315. The grip 35 in the first configuration is adapted to be disposed within the accommodating cavity 22 when the toolset 30 is in the combination configuration. When the toolset 30 is in not in the combination configuration and includes the second connecting hole 316 disposed outside the accommodating cavity 22, the grip 35 is connectible to the chain tool body 31 in the second configuration.

Moreover, the toolset 30 includes a driver bit 36 selectively positionable in a first position and a second position. The driver bit 36 in the first position is inserted in a cavity 352 in the grip 35. The driver bit 36 is adapted to be arranged in the first position when the grip 35 is in the first configuration. The driver bit 36 in the second position includes a first driving end 361 detachably fastened to the ratchet drive head 21 and a second driving end 362 detachably fastened to the extractor bolt 33. Specifically, the ratchet drive head 21 includes the first driving portion 211 to which a driving tool is adapted to couple, and the extractor bolt 33 includes the second driving portion 332 to which a driving tool is adapted to couple.

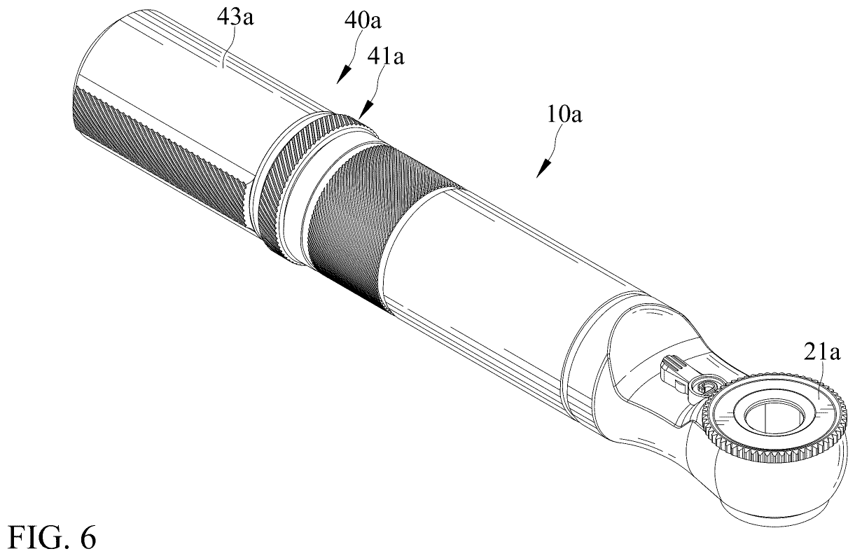

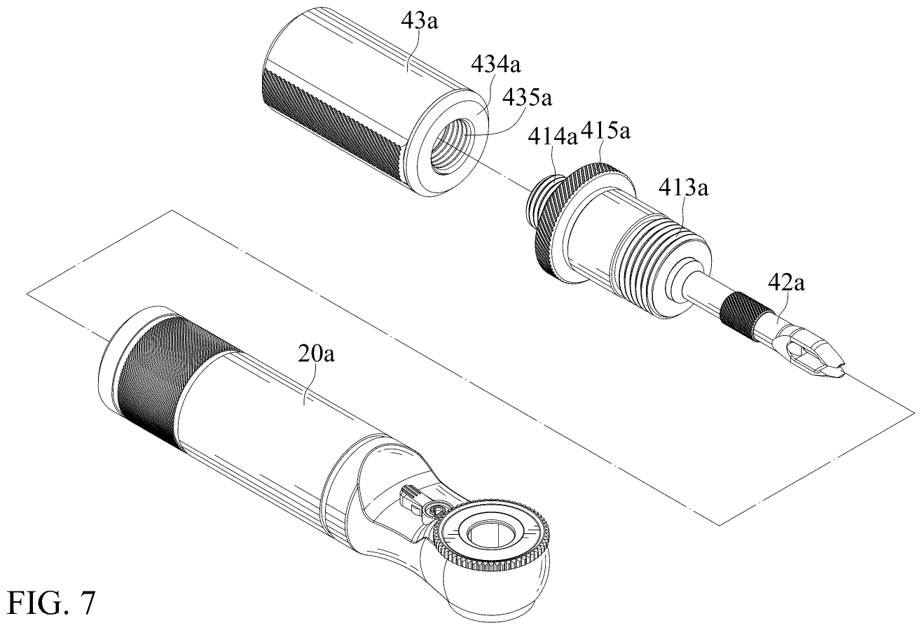

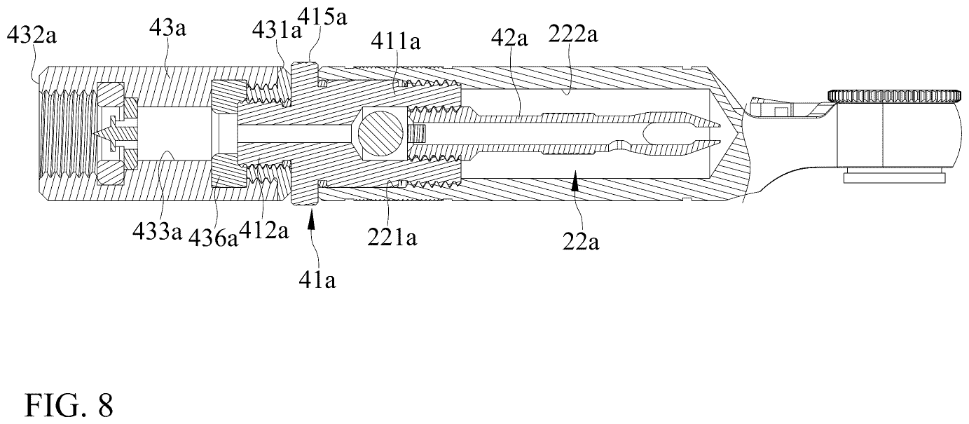

FIGS. 6 through 8 show a ratchet wrench 10a including a bicycle toolset 40a combined therewith in accordance with a second embodiment of the present invention, and the same numbers are used to correlate similar components of the first embodiment, but bearing a letter a. The ratchet wrench 10a has a main body 20a which has a first end including a ratchet drive head 21a and a second end including an accommodating cavity 22a. The accommodating cavity 22a has a first section 221a and a second section 222a. The first section 221a is adjacent to an open end of the accommodating cavity 22a. The second section 222a is connected to the first section 221a and adjacent to the ratchet drive head 21a. The second embodiment is different from the first embodiment in that a toolset 40a is different from the toolset 30.

The toolset 40a includes a connector 41a, a plug 42a, and an inflator adapter 43a. The connector 41a has a first connecting portion 411a and a second connecting portion 412a at different ends. The inflator adapter 43a includes a coupling end 431a and an inflator end 432a at different ends. When the toolset 40a is in the combination configuration, the connector 41a and the plug 42a and the inflator adapter 43a are coupled with one another, the first connecting portion 411a is detachably fastened to the main body 20a and disposed in the accommodating cavity 22a, the plug 42a is connected to the first connecting portion 411a and disposed in the accommodating cavity 22a, and the coupling end 431a is detachably connected to the second connecting portion 412a. Specifically, the first connecting portion 411a and the first section 221a are detachably connected with each other and the plug 42a is inserted in the second section 222a. The inflator end 432a is connectible to an inflator (not shown) which is useful for supplying air to the inflator adapter 43a. The inflator adapter 43a has an air channel 433a communicating and extending from the coupling end 431a to the inflator end 432a. The air channel 433a includes an airtight ring 436a disposed therein. When the connector 41a and the inflator adapter 43a are coupled with each other, the second connecting portion 412a is inserted into the air channel 433a and abuts the airtight ring 436a, the connector 41a includes first external threads 413a on the first connecting portion 411a threadly engaged with an inner periphery of the accommodating cavity 22a and second external threads 414a on the second connecting portion 412a disposed outside the accommodating cavity 22a, and the coupling end 431a includes a connecting structure 434a having internal threads 435a and engaged with second external threads 414a. Additionally, the connector 41a includes a flange 415a extending radially outward from an outer periphery thereof. The flange 415a is disposed between the first and the second connecting portions 411a and 412a. When the toolset 40a is in the combination configuration, the main body 20a includes an end, which is opposite to the ratchet drive head 21a, abutting a first side of the flange 415a. When the connector 41a and the inflator adapter 43a are coupled with each other and the second connecting portion 412a is inserted into the air channel 433a, the inflator adapter 43a includes an end opposite to the inflator end 432a abutting a second side of the flange 415a.

In view of the foregoing, the ratchet wrench 10 and 10a include bicycle toolsets 30 and 40a combined therewith of the present invention have compact designs and therefore they are light in weight and easy to carry. Further, they help a user reduce the burden of carrying many bicycle tools.

The foregoing is merely illustrative of the principles of this invention, and various modifications can be made by those skilled in the art without departing from the scope and spirit of the invention.

What is claimed:

1. A ratchet wrench including a bicycle toolset combined therewith comprising:
a main body having a first end including a ratchet drive head and a second end including an accommodating cavity; and
a toolset detachably connected to the main body in a combination configuration, wherein the toolset comprises a connector having a first connecting portion and a second connecting portion at different ends, a plug, and an inflator adapter including a coupling end and an inflator end at different ends;
wherein, in the combination configuration, the connector, the plug, and the inflator adapter are coupled with one another, the first connecting portion is detachably fastened to the main body and disposed in the accommodating cavity, the plug is connected to the first connecting portion and disposed in the accommodating cavity, the coupling end is detachably connected to the second connecting portion, the second connecting portion is inserted into an air channel of the inflator adapter, communicating and extending from the coupling end to the inflator end.

2. The ratchet wrench including the bicycle toolset combined therewith as claimed in claim 1, wherein the inflator end is connectible to an inflator for supplying air to the inflator adapter.

3. The ratchet wrench including the bicycle toolset combined therewith as claimed in claim 1, wherein the air channel includes an airtight ring disposed therein, and wherein when the connector and inflator adapter are coupled, the second connecting portion abuts the airtight ring.

4. The ratchet wrench including the bicycle toolset combined therewith as claimed in claim 1, wherein when the connector and the inflator adapter are coupled, the connector includes first external threads on the first connecting portion engaged with an inner periphery of the accommodating cavity, the connector includes second external threads on the second connecting portion disposed outside the accommodating cavity, and the coupling end includes a connecting structure with internal threads engaged with the second external threads.

5. The ratchet wrench including the bicycle toolset combined therewith as claimed in claim 3, wherein when the connector and the inflator adapter are coupled, the second connecting portion abuts the airtight ring.

6. The ratchet wrench including the bicycle toolset combined therewith as claimed in claim 1, wherein the accommodating cavity includes a first section adjacent to an open end of the accommodating cavity, and a second section connected to the first section and adjacent to the ratchet drive head, the first connecting portion and the first section being detachably connected, and the plug being inserted in the second section when the toolset is in the combination configuration.

7. The ratchet wrench including the bicycle toolset combined therewith as claimed in claim 1, wherein the connector includes a flange extending radially outward from an outer periphery thereof, and the flange disposed between the first and the second connecting portions.

8. The ratchet wrench including the bicycle toolset combined therewith as claimed in claim 7, wherein when the toolset is in the combination configuration, the main body includes an end opposite to the ratchet drive head abutting a first side of the flange, and when the connector and the inflator adapter are coupled and the second connecting portion is inserted into the air channel, the inflator adapter includes an end opposite to the inflator end abutting a second side of the flange.
